(19) United States
(12) Patent Application Publication
(10) Pub. No.: US 2015/0377793 A1
(43) Pub. Date: Dec. 31, 2015

(54) COMPUTERIZED METHOD AND SYSTEM FOR LIGHT PERFORMANCE GRADING OF GEMSTONES BY ONE SINGLE GRADING SCALE

(71) Applicant: SARINE COLOR TECHNOLOGIES LTD., Kfar Saba (IL)

(72) Inventors: Uzi LEVAMI, Hod Hasharon (IL); Akiva CASPI, Nirit (IL)

(73) Assignee: Sarine Color Technologies Ltd., Kfar Saba, IL (US)

(21) Appl. No.: 14/766,432

(22) PCT Filed: Feb. 11, 2014
(86) PCT No.: PCT/IL2014/050145

§ 371 Date: Aug. 6, 2015

Related U.S. Application Data
(63) Continuation of application No. 14/024,314, filed on Sep. 11, 2013.
(60) Provisional application No. 61/763,342, filed on Feb. 11, 2013.

(51) Int. Cl. G01N 21/87

(52) U.S. Cl. CPC G01N 21/87

(57) ABSTRACT

There are provided a computerized method of grading a gemstone and a system thereof. The method comprises: upon obtaining in a memory of a computer a single grading scale including for each parameter a sub-grade scale, borderlines thereof, unique groups of values of the parameter and final grades corresponding to the unique groups; and upon obtaining values of the parameters of the gemstone to be graded, assigning to the obtained value of each parameter its sub-grade using the sub-grade scale and borderlines thereof specified in the single grading scale; recognizing among the unique groups specified in the single grading scale a unique group corresponding to the assigned sub-grades; and assigning to the gemstone, in accordance with the recognized unique group, a final grade in the single grading scale.

The present application claims priority from U.S. provisional application No. 61/763,342 filed Feb. 11, 2013, and from U.S. patent application Ser. No. 14/024,314 filed Sep. 11, 2013, whose entire contents are incorporated herein by reference.

### FIELD

The currently disclosed subject matter pertains in general to the grading of gemstones, and more particularly to the producing of gemstone grading scales.

### BACKGROUND

Among known methods and systems for diamond grading the most popular in the trade are those of the Gemological Institute of America (GIA) used for grading the four ‘C’s (4Cs) of diamond including carat, cut, color and clarity.

In addition to the above 4Cs grading, a variety of attempts have been made to grade gemstones based on their parameters other than the 4Cs, relating to the light performance and beauty of gemstones, and examples of these are disclosed in U.S. Pat. No. 6,786,733, U.S. Pat. No. 7,414,709 and US 2002/0052170.

### SUMMARY

One aspect of the currently disclosed subject matter relates to a method of generating a single grading scale for gemstones using a computer comprising a processor operatively coupled to a memory, the method comprising:
setting a plurality of grades characterizing the single grading scale from high to low, and setting an aimed statistic distribution of gemstones through the grades in said grading scale;

defining parameters of gemstones, based on which the grading is to be performed;
obtaining values of each parameter for each gemstone in a statistically relevant sample of gemstones, thus giving rise to a plurality of the values for each parameter;
processing the plurality of the obtained values by deriving from the values unique groups relating to all the parameters;
generating clusters of the unique groups to define respective grades of the plurality of grades so that a distribution of the gemstones in the statistically relevant sample in accordance with the generated clusters corresponds to the aimed statistic distribution in the single grading scale; and
storing in the memory a data structure comprising the generated clusters associated with the respective grades, the stored data structure to be used as the single grading scale for grading a gemstone characterized by specific values of the defined parameters.

The above single scale can be used to grade any gemstone, e.g. a diamond, as a whole based on its light performance, e.g. based on such parameters as brilliance, fire, scintillation, light symmetry, and can enable anyone to compare diamonds using one scale of single final-grades relating to light performance, arranged in a hierarchical sequence to represent stone quality in defined and sequential steps between two extremes of maximum and minimum.

The fact that the above method of producing a single grading scale is based on the use of the aimed statistic distribution of gemstones through the grades and on measurements performed in the statistically relevant sample and processed in accordance with the aimed statistic distribution, ensures that the resulting single grading scale accurately and consistently reflects gemstone value based on the actually existing gemstone distribution in the trade. Namely, a diamond which receives a high grading according to the above single grading scale, will statistically also receive similarly high grading according to the grading systems promoted today by AGS and GIA for the 4Cs. The added value is the simplicity of the scale. Instead of having to consider and weigh a multitude of grades for brilliance, fire, scintillation and light symmetry, a customer now has the valuation of a gemstone at a glance, reflected in one simple term out of a single scale of a relatively low number of quality steps, reflected in distinct steps from lowest to highest.

The clusters in the above method can comprise unique groups of unique ranges of the measured values.

The values of the parameters can be obtained based on images taken under lighting conditions suitable for revealing the specific parameter being measured. Such images can be images of real gemstones taken under real lighting conditions, or they can be virtual images of virtual, modeled gemstones, modeled under virtual lighting conditions, produced by optical Computer-Aided Engineering methods/devices, such as ray tracing methods/systems and the like.

In addition establishing at least one of the statistically relevant sample or the aimed distribution can be based on the use of the 4Cs grading method widely accepted in the diamonds trade. Since the trade heavily relies on this method, basing the definition of the statistically relevant sample on it will lead to a high reliability in relation to the correlation of the sample to the totality of gemstones existing in the trade. However, there are other possibilities for ascertaining such a reliable correlation, such as measuring diamonds that belong to the same carat size range (for example diamonds that are from 0.50 carat to 0.60 carat), same clarity range and same color range and are sorted by the owner in different pricing. The light performance of the higher priced diamonds should be better than these of the lower priced diamonds.

The method can comprise setting for each of the defined parameters a scale of sub-grades from high to low. There is a variety of strategies available for such setting of a scale. One example is to set the same sub-grade scale for all parameters of all the measured gemstones. Such sub-grades can be named, for better support in the trade, with same names as used in existing grading methods, such as Excellent, Very Good, Good, Fair and Poor, or naming new terms can be used to distinguish from the existing grading methods such as Ultimate, Very High, High, Standard and Low. Another example is to set individual sub-grade scales per parameter.

The method can include assigning to each sub-grade of each defined parameter a unique range of its measured values. The measured values for each parameter can be normalized in a common scale for all the parameters.

The generating of clusters of unique groups derived from the measured values, relating to all the defined parameters, to define respective grades of the plurality of grades so that a distribution of the gemstones in the statistically relevant sample in accordance with the generated clusters corresponds to the aimed statistic distribution in the single grading scale, can comprise:
generating, by the processor, the unique groups of the unique ranges, each unique group constituted by one unique range for each of the defined parameters;
assigning, by the processor, for each unique group of the unique ranges a respective rate;
clustering, by the processor, the unique groups in accordance with the assigned rates.

The value of each parameter for each gemstone in a statistically relevant sample of gemstones can be obtained, for example, from any one or more of the following:
directly or indirectly measuring the values in real stones by the same system that performs processing the plurality of the measured values, by deriving from the measured values unique groups relating to all the parameters;
acquisition and subsequent analysis of images of real stones recorded by an entity other than the above system, to derive the values therefrom;
obtaining numerical data on the light performance of real stones and subsequent assignment of the values based on such numerical data;
3D modeling real stones and subsequently performing computer simulations based thereon to obtain a virtual light return, and corresponding assignment of the values;
using cross-correlation charts that assign the values to real stones based on other, optical or non-optical data correlated with light performance parameters obtained previously for other stones;

The method can further include generating the unique groups of the unique ranges in accordance with an aimed statistic distribution of gemstones through the sub-grades in the single scale of sub-grades for each of the defined parameters.

When generating the clusters, the method can further include comparing, by the processor, the distribution in the statistically relevant sample of gemstones in accordance with the generated clusters with the aimed statistic distribution, and if the aimed distribution is not reached, further performing re-defining unique ranges or re-clustering unique groups for at least two grades, in order to bring the obtained distribution into conformity with the aimed distribution.

The re-defining unique ranges can be performed by shifting their borderline between at least two unique ranges of the parameters values. The re-clustering unique groups can be performed by re-assigning to a new final-grade at least one unique group previously assigned to a previous final-grade, the new and the previous final-grades being neighboring final-grades.

In accordance with another aspect of the presently disclosed subject matter, there is further provided a method of grading gemstones based on a single grading scale wherein each single grade in the scale is associated with unique groups of unique value ranges of the parameters of gemstones in a statistically relevant sample of gemstones, the unique groups being established at least based on an aimed statistic distribution of gemstones through the grades in the grading scale and, optionally, a sub-grades scale in which each value range corresponds to a sub-grade in the sub-grade scale for each parameter. The method comprises: obtaining the selected parameters of a gemstone; and determining a single grade based on the measurement and the single grading scale, and optionally, determining a sub-grade for each parameter in its corresponding sub-grade scale.

With respect to this aspect, the values of the selected parameters can be obtained, for example, by any one or more of the following:
directly or indirectly measuring the values in real stones by the same system that performs processing the plurality of the measured values by deriving from the measured values unique groups relating to all the parameters;
acquisition and subsequent analysis of images of real stones recorded by an entity other than the above system, to derive the values therefrom;
obtaining numerical data on the light performance of real stones and subsequent assignment of the values based on such numerical data;
3D modeling real stones and subsequently performing computer simulations based thereon to obtain a virtual light return, and corresponding assignment of the values;
using cross-correlation charts that assign the values to real stones based on other, optical or non-optical data correlated with such light performance parameters obtained previously for other stones;

In a still further aspect, there is provided a single grading scale recorded on a non-transitory computer-readable medium and producible by a method using a computer comprising a processor operatively coupled to a memory, the method comprising:
setting a plurality of grades characterizing the single grading scale from high to low, and setting an aimed statistic distribution of gemstones through the grades in said grading scale;
defining parameters of gemstones, based on which the grading is to be performed;
obtaining values of each parameter for each gemstone in a statistically relevant sample of gemstones, thus giving rise to a plurality of the measured values for each parameter;
processing the plurality of the measured values by deriving from the measured values unique groups relating to all the parameters;
generating clusters of the unique groups to define respective grades of the plurality of grades so that a distribution of the gemstones in the statistically relevant sample is in accordance with the generated clusters corresponds to the aimed statistic distribution in the single grading scale; and
storing in the memory a data structure comprising the generated clusters associated with the respective grades, the stored data structure to be used as the single grading scale for grading a gemstone characterized by specific values of the defined parameters.

In a next aspect, there is provided a single grading scale recorded on a non-transitory computer-readable medium and capable of being used for grading a gemstone based on pre-defined parameters thereof, wherein each single grade in the scale is associated with unique groups of unique value ranges of the parameters of gemstones in a statistically relevant sample of gemstones, the unique groups being established at least based on an aimed statistic distribution of gemstones through the grades in the grading scale.

The method by which the grading scale of this aspect is producible can further include establishing the unique groups also based on an aimed statistic distribution of gemstones for all value ranges of each parameter.

In a further aspect, there is presented a single grading scale recorded on a non-transitory computer-readable medium and capable of being used for grading a gemstone based on pre-defined parameters thereof, wherein each single grade in the scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in the grading scale.

This aspect can further include the correspondence between each value range and each corresponding sub-grade based on an aimed statistic distribution of the gemstones in the single sub-grade scale for each parameter.

In a still further aspect, there is presented a single grading scale for gemstones defined by the Table 1 and Table 2 presented in the Detailed Description below and recorded on a non-transitory computer-readable medium.

In a still further aspect, there is provided a system capable of generating a single grading scale for gemstones based on values of predefined parameters thereof, the system comprising one or more input interfaces operatively coupled to a memory and a processor. The one or more input interfaces are configured to enable setting and storing in the memory a plurality of grades characterizing the single grading scale from high to low, an aimed statistic distribution of gemstones through the grades in said grading scale; and parameters of gemstones, based on which the grading is to be performed, obtaining values of each of said parameter for each gemstone in a statistically relevant sample of gemstones, thus giving rise to a plurality of the values for each parameter out of the set parameters. The processor is configured to process said plurality of values by deriving from said values unique groups relating to all the parameters and to generate clusters of said unique groups to define respective grades of said plurality of grades so that a distribution of the gemstones in said statistically relevant sample in accordance with the generated clusters corresponds to said aimed statistic distribution in the single grading scale; and to store in the memory a data structure comprising the generated clusters associated with the respective grades, the stored data structure to be used as the single grading scale for grading a gemstone characterized by specific values of said defined parameters.

This aspect can further include one or more of the following features:
the parameters comprising at least one of brilliance, fire, scintillation and light symmetry;
the clusters comprising unique groups of unique ranges of said measured values;
the processor further being configured to:
   assign to each sub-grade of each defined parameter a unique range of said measured values corresponding to the respective parameter;
   generate said clusters by including the operation of generating the unique groups of the unique ranges, each unique group constituted by one unique range for each of the defined parameter;
   assign for each unique group of the unique ranges a respective rate;
   cluster the unique groups in accordance with the assigned rates.
the processor being further configured for setting for each of the defined parameters a scale of sub-grades, which is constituted by setting a single scale of sub-grades for all the defined parameters;
the processor being further configured for generating the unique groups of the unique ranges in accordance with an aimed statistic distribution of gemstones through the sub-grades in said single scale of sub-grades for each of the defined parameters;
the processor further being configured for generating the clusters by the operation of comparing the distribution of the gemstones in said statistically relevant sample in accordance with the generated clusters with the aimed statistic distribution, and if the aimed distribution is not reached, further including the operation of performing at least one of the following steps in order to bring the former distribution into conformity with the latter distribution: re-defining unique ranges or re-clustering unique groups for at least two grades;
the processor being further configured to perform the step of re-clustering unique groups by re-assigning to a new final-grade at least one unique group previously assigned to a previous final-grade, said new and said previous final-grades being neighboring final-grades;
said first interface being configured for obtaining said values based on images taken under lighting conditions suitable for revealing the specific parameter being measured;
the processor further being configured for establishing at least one of said statistically relevant sample or said aimed distribution based on the use of the 4Cs grading system of diamonds.

In a still further aspect, there is provided a system capable of grading a gemstone based on its light performance parameters. The system comprises: a memory configured to store a single grading scale including for each parameter a sub-grade scale, borderlines thereof, unique groups of values of the parameter and final grades corresponding to the unique groups, and to obtain for at least temporal storage values of the parameters of the gemstone to be graded. The system further comprises a processor operatively connected to the memory and configured to: assign to the obtained value of each parameter its sub-grade using the sub-grade scale and borderlines thereof specified in the single grading scale; recognize among the unique groups specified in the single grading scale a unique group corresponding to the assigned sub-grades; and assign to the gemstone, in accordance with the recognized unique group, a final grade in the single grading scale.

The system in accordance with this aspect can further include at least one of the following:
a stage for mounting a gemstone and one or more measuring devices operatively coupled to the interface, the device being configured for measuring the parameters of the gemstone to provide the values by taking its electronic images under varying illumination conditions;
an interface configured to produce a gemstone grading report in accordance with the grading provided by the processor;
means of generating multiple light environments to provide conditions needed for measuring said parameters;
a measuring device for receiving light return from the gemstone in multiple light environments and for communicating the measured signal to a computer;
a communication interface (e.g. communication port) configured to receive measured signals from a measuring device;
a communication interface (e.g. communication port) configured to communicate grading results.

In accordance with a further aspect, there is provided a system comprising a computer-readable non-transitory storage medium containing a computer-readable data and instructions for producing a single grading scale of light performance in accordance with any of the aspects hereinabove; the non-transitory storage medium, the computer-readable data and the instructions having a form that can be integrated into any other system, which is configured for executing the method according to any of the aspects of the subject matter of the present application.

In accordance with a still further aspect of the presently disclosed subject matter, there is provided a method for grading a gemstone by a system, based on
parameters based on which the grading is to be performed;
quantity of sub-grades of the parameters;
borderlines that dissect the values of each parameter to form sub-grades;
combinations of parameters and sub-grades based on counting the same sub-grades;
quantity of final-grades of the single grading scale;
assignment of each combination to a final-grade;

The method comprises, upon obtaining in a memory of a computer a single grading scale including for each parameter a sub-grade scale, borderlines thereof, unique groups of values of the parameter and final grades corresponding to the unique groups; and upon obtaining values of the parameters of the gemstone to be graded, assigning to the obtained value of each parameter its sub-grade using the sub-grade scale and borderlines thereof specified in the single grading scale; recognizing among the unique groups specified in the single grading scale a unique group corresponding to the assigned sub-grades; and assigning to the gemstone, in accordance with the recognized unique group, a final grade in the single grading scale.

In a still further aspect, there is presented a gemstone grading report recorded on a non-transitory computer-readable medium, and comprising indication of a grade for the gemstone in a single grading scale based on pre-defined parameters thereof, wherein each single grade in the scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in the grading scale.

In this aspect, the grading report can further include:
a sub-grade for each parameter in the single sub-grade scale;
data stored in and extractable from a database located on a computer, which is accessible locally or globally via any of the known methods in the art.

In accordance with a still further aspect of the invention, there is provided a report for a measured gemstone, including, for each parameter

its sub-grade and the final grade in the single grading scale established according to the method described hereinabove.

The above presented aspects thus provide methods, systems and reports for grading gemstones by one single grading scale, and, optionally, by a plurality of sub-grades of a sub-grade scale for a plurality of properties of such gemstones.

It needs to be noted that any of the above aspects can include as parameters the parameters of brilliance, fire, scintillation, light symmetry. Furthermore, it is clear to the skilled person that any other parameters can be defined to be included in the above total grading scale.

The hereinbefore described aspects associated with the single grading scale as described above offer a novel approach to grading gemstones based on transparent, repeatable procedures and conditions, and resulting in a simple, convenient single grade per gemstone.

By this token, the single grading scale can fulfill a need for simplified communication on a common basis, without thereby compromising on depth of considerations regarding the different factors that influence the evaluation of gemstones.

It should be indicated that all the above aspects are applicable not only to grading real polished gemstones but also to providing predicted light performance grading of a stone to be cut from a rough gemstone. In this case, the predicted light performance can be calculated based on the planned geometry and proportions of the stone to be cut by applying ray-tracing methods to a computer-generated 3D model of such stone, which can optionally include computer generated models of internal inclusions in the rough stone. Such predicted light performance grading can constitute an additional consideration when deciding on a cutting plan for the rough gemstone.

### BRIEF DESCRIPTION OF THE DRAWINGS

FIG. 1 illustrates a generalized functional block diagram of a system capable of producing a single grading scale for gemstones in accordance with certain examples of the presently disclosed subject matter;

FIG. 2 illustrates a generalized flow-chart, which schematically presents different stages and steps of a method of producing a single grading scale for gemstones based on a number of their light performance parameters, according to certain examples of the presently disclosed subject matter;

FIG. 3 illustrates one example of a sub-grade scale, which can be used for grading each light performance parameter in accordance with certain examples of the presently disclosed subject matter;

FIG. 4 illustrates how gemstones can be characterized by grading their light performance parameters using the sub-grade scale of FIG. 3;

FIG. 5 illustrates a generalized flow-chart of operating a system of the kind illustrated in FIG. 1, when producing a single grading scale for gemstones in accordance with certain examples of the presently disclosed subject matter;

FIG. 6 schematically illustrates a system for grading gemstones using a single grading scale produced in accordance with certain examples of the presently disclosed subject matter;

FIGS. 7A and 7B illustrate examples of a report that can be provided using a single grading scale produced in accordance with certain examples of the presently disclosed subject matter; and

FIG. 8 illustrates a generalized flow-chart of a process of grading a gemstone using a single grading scale produced in accordance with certain examples of the presently disclosed subject matter.

### DETAILED DESCRIPTION

In the following detailed description, numerous specific details are set forth in order to provide a thorough understanding of the invention. However, it will be understood by those skilled in the art that the presently described subject matter can be practiced without these specific details. In other instances, well-known methods, procedures, components and circuits have not been described in detail so as not to obscure the description.

Unless specifically stated otherwise, as apparent from the following discussions, it is appreciated that throughout the specification discussions utilizing terms such as “processing”, “computing”, “calculating”, “determining”, “generating”, “configuring” or the like, refer to the action and/or processes of a computer that manipulate and/or transform data into other data, the data represented as physical, such as electronic, quantities and/or the data representing the physical objects. The term “computer” should be expansively construed to cover any kind of electronic device with data processing capabilities.

The operations in accordance with the teachings herein can be performed by a computer specially constructed for the desired purposes or by a general-purpose computer specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

It is to be understood that the term “non-transitory” is used herein to exclude transitory, propagating signals, but to include, otherwise, any volatile or non-volatile computer memory technology suitable to the presently disclosed subject matter.

As an example throughout this detailed description, the gemstones graded are diamonds, and the terms “gemstone” and “diamond” are understood to be interchangeable. However, it is clear to the skilled person, that any other type of gemstone can be graded by the herein disclosed methods and systems.

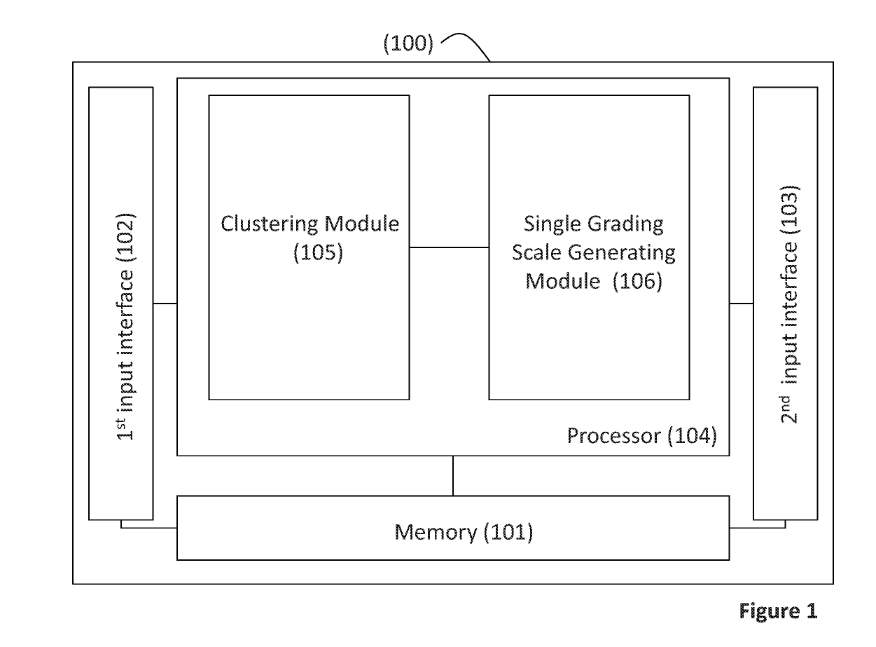

Bearing the above in mind, attention is first drawn to FIG. 1, illustrating a generalized functional block diagram of a system capable of producing a single grading scale for gemstones based on a number of their parameters, in accordance with certain examples of the presently disclosed subject matter. The illustrated system 100 comprises a memory 101 implemented on a non-transitory storage medium and configured to accommodate first data. First data comprises a plurality of values of the parameters characterizing gemstones in a statistically relevant sample of gemstones, which values can be received via a first input interface 102 operatively coupled to the memory 101. The first input interface 102 can be configured to obtain the first data from any suitable external database/s and/or measuring system/s. The first input interface can be further configured to receive results of measurements performed on at least a part of the statistically relevant sample of gemstones by a measuring system (e.g. images taken under lighting conditions suitable for revealing each parameter being measured), the results being configured for deriving therefrom, by a processor having a dedicated software, values of the parameters constituting at least a part of the first data.

The memory 101 is further configured to accommodate second data. The second data comprises a plurality of grades ordered from high to low and defined as characterizing the single grading scale; an aimed statistic distribution of gemstones through the grades in the grading scale; the parameters of gemstones, based on which the grading is to be performed (e.g. these can be light performance parameters such as for example any combination of brilliance, fire, sparkle also known as scintillation, and light symmetry), and a sub-grade scale for each of the parameters. The second data can be received via a second input interface 103. The second input interface can be configured as a user interface enabling a user to input the second data or a part thereof. Alternatively or additionally, the second input interface 103 can be configured as a communication port capable to obtain at least part of the second data from external databases and/or any other suitable external source.

The system 100 further comprises a processor 104 operatively coupled to the memory 101, to the first input interface 102 and to the second input interface 103. The processor can be configured to provide instructions to the input interfaces to obtain at least part of the above first and/or second data to be stored in the memory 101, and the input interfaces can be configured to communicate with respective data sources in order to obtain the data.

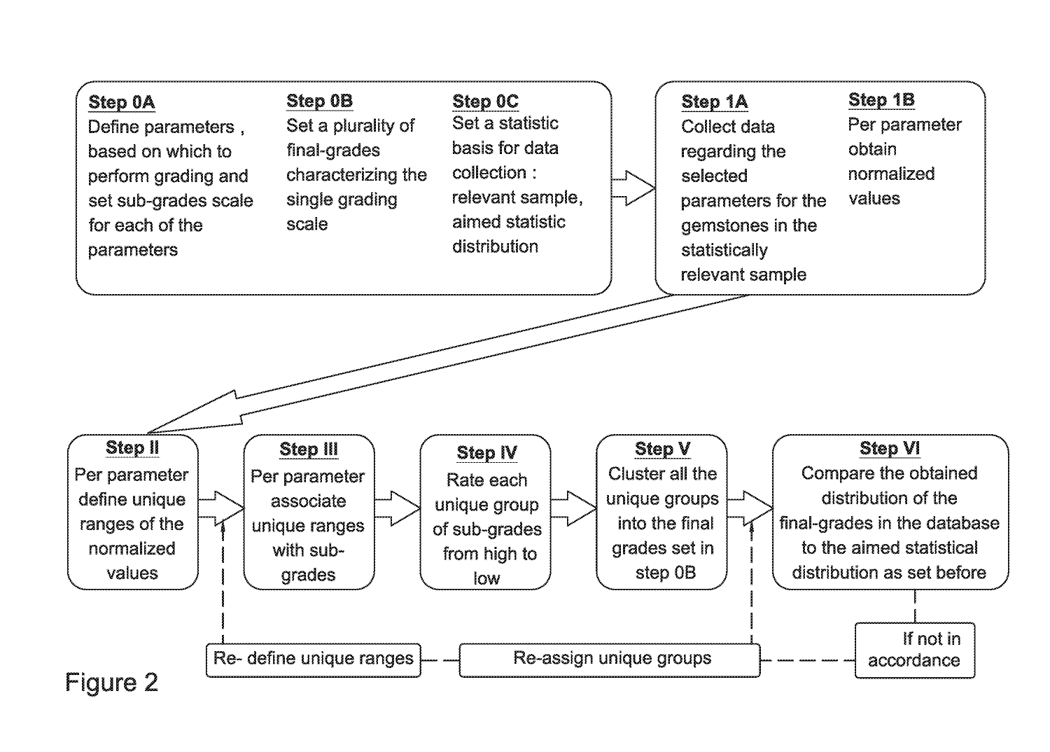

As will be further detailed with reference to FIGS. 2-5, the processor 104 is configured to use the first and the second data when providing processing necessary for generating the single grading in accordance with certain examples of the presently disclosed subject matter. Optionally, the processor can comprise a clustering module 105 and a single grading scale generating module 106 further detailed with reference to FIGS. 2-5.

Note that the currently disclosed subject matter is not bound by the specific single grading generating system described with reference to FIG. 1. Equivalent and/or modified functionality can be consolidated or divided in another manner and can be implemented in any appropriate combination of software, firmware and hardware, (e.g. in a suitably programmed computer).

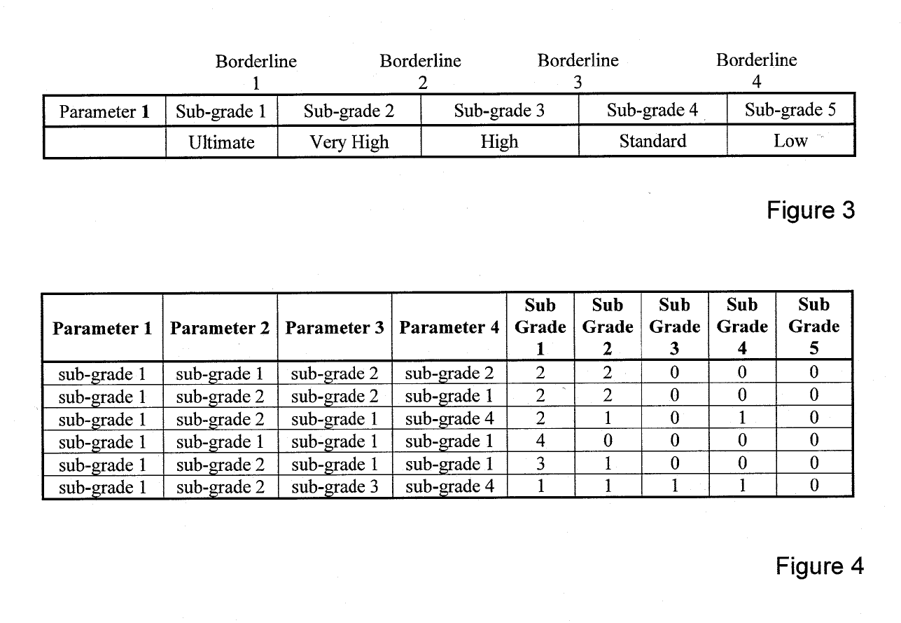

Referring to FIG. 2, there is presented a generalized flow-chart schematically illustrating a non-limiting example of different stages of a method of producing a single grading scale for light performance grading of gemstones. As presented in FIG. 2, the described method can generally be divided into the following stages:
setting scale's basic definitions, including setting parameters, based on which gemstones are to be graded by the single grading scale (step 0A); setting a plurality of sub-grades for each of the parameters; setting a plurality of final grades characterizing the single grading scale (step 0B), and setting a statistic basis for data collection (step 0C);
collecting data regarding the selected parameters from a statistically relevant sample of gemstones (steps IA and IB), and
analyzing and processing the collected data to produce the single grading scale (steps II to VI) as will be further detailed with reference to FIGS. 3 to 5.

As illustrated in step 0A in FIG. 2, the first thing in the described method is to define the parameters of gemstones, based on which the single grading scale of their light performance is to be produced.

In the described example, these parameters can be four typical light performance parameters of a gemstone: brilliance, fire, sparkle (also known as scintillation) and light symmetry.

In addition, the number of sub-grades scale needs to be determined for each parameter needs. In general, the number of sub-grades can be any number acceptable in grading gemstones and normally selected by graders. More particulars about the sub-grade scale are presented in the description of step III below.

In step 0B in FIG. 2, plurality N of final grades characterizing the single grading scale from the highest N_{high} to the lowest N_{low} grade, are set. The number of final grades N between the highest and the lowest grades can be any number acceptable in grading gemstones and normally selected by graders. In the example illustrated in Table 2, to which reference will be made below with more detailed explanations, the number of final grades is nine.

In step 0C in FIG. 2, a statistic basis for data collection is set including the definition of a statistically relevant sample of gemstones and setting an aimed statistic distribution of gemstones through the final grades set for the single grading scale.

In case of diamonds, the statistically relevant sample of gemstones is determined so as to ensure that data to be collected therefrom covers most kinds of diamonds that are known in the trade.

In the present example, the statistically relevant sample has been determined, using the fact that all diamonds in the trade can be graded by their 4Cs values, that values of each of the 4Cs can be grouped into groups (for example, the color grades D E F can be grouped into one group), and that segments can be formed by the combination of such different groups.

Below is an example of a possible segmentation of the 4Cs used in the present embodiment, based on their grades according to the GIA scale.

The carat grouping depends on the grader's decision since carat values are a continuum from 0.001 to huge size of 300.00 carats. The grader will, for example, group them in groups such as: 0 to 0.24; 0.25 to 0.49; 0.50 to 0.99; 1.00 to 1.49; 1.50 to 1.99; 2.00 to 3.99; 4.00 and above, to amount to a total of 7 segments.

Clarity grades are: IF; VVS1; VVS2; VS1; VS2; SI1; SI2; SI3; I1; I2; 13—a total of 11 groups.

Color Grade: D to F; G to I; J to L; M and above—a total of 4 groups

Cut Grade: Excellent; Very Good; Good; Fair; Poor—a total of 5 grades, which in this case form one group per grade.

A segment in the database can thus be a combination of different 4Cs groups. An example of a segment is:
Carat weight from 0.25 carats to 0.49 carats;
Clarity Grade using the GIA scale IF to VS2;
Color Grade using the GIA scale of color D to F;
Cut Grade using the GIA scale of Excellent.

It is clear to the skilled person that there are many more ways of segmentation of the 4Cs, and the hereinabove described segmentation is but one example of them.

The total quantity of segments according to the above example is thus the multiplication of the quantity of segments in each C for all the Cs, which is 7×11×4×5, i.e. 1,540 segments.

To ensure that a sample of diamonds will be in fact statistically relevant, each segment should include substantial quantity of diamonds, from which data regarding their parameters will be collected to have enough data to enable statistics analysis. Such a substantial quantity for each segment can be between 16 to 100 stones, more particularly, between 17 and 50, even more adequately between 18 and 30; in an exemplary case, a number of 20 stones per segment has proven to be sufficient. With each segment including 20 diamonds, there the statistically relevant sample will include 30,800 diamonds.

The aimed statistic distribution can be set based on obtaining data that represents the trade. This can be done by addressing multiple players in the trade. This includes large wholesalers, diamond manufacturers of variety of goods, and other players in the trade.

Additional input to the segmentation of the trade is by analyzing trade websites and determining the statistics of each diamond segment, e.g. where this data is open to the public.

The segments should not have even size distribution since the distribution in the trade itself is not even. The statistical distribution of each segment should be defined as well. This is used to define how many diamonds are needed from each segment to meet the data collection goal for producing the statistically relevant sample.

Each one of the players describes the typical goods that he manufactures or sells and the distribution of his goods. For example, a manufacturer that cuts diamonds that cover a certain size range (0.25 ct. to 2.50 ct.); certain clarity range (IF to VS2) and color range (D to J). In most cases internal sorting of superior and inferior goods is performed. In these cases the internal sorting prices are set so that superior goods are priced higher than inferior goods. The difference of pricing is later used to determine if the method reflects that better (higher priced) goods statistically score higher final-grade than goods with lower pricing.

This enables mapping the gemstones to the segments that were set as goals for data collection to produce the statistically relevant sample, and determining intended statistical quantity distribution of diamonds between the final-grades in the single grading scale in accordance therewith. For example, the expectation is that for high clarity diamonds (IF to VVS), with high color (D to F) and for high cut grade (Excellent), the grades in the single grading scale will be statistically higher than for diamonds with low clarity (I) low color (M and above) and low cut grade (Poor).

It should be clear to the skilled person that any number of final grades, with any names or indications of quality can be chosen, and that the aimed statistical distribution can depend on a wide variety of criteria. It is further clear to the skilled person that such a grading scale will depend on the parameters defined, and can, at this stage of the process, be a first preliminary choice, to later be adjusted.

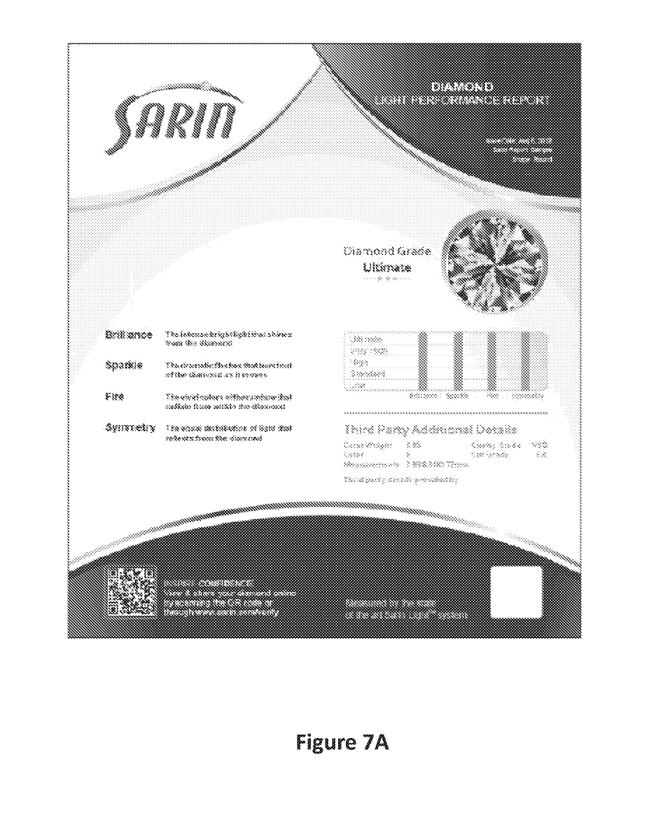

In step IA in FIG. 2, data regarding the selected parameters for the gemstones in the statistically relevant sample is collected either by measuring these parameters, e.g. by scanning each gemstone in the sample by a suitable system (an example of such system is further detailed with reference to FIG. 6), or by otherwise obtaining measured, derived or simulated values for the respective parameters.

In step IB in FIG. 2, the values of the parameters obtained in step IA are normalized to bring them to a single scale, for example from 0 to 100. In this respect it should be obvious to a skilled person, that any other scales of normalization can be used.

It should be noted that, in alternative examples not discussed, the values of respective parameters can be not normalized.

In step II of FIG. 2, the normalized values of each of the selected parameters are then segmented into unique ranges of values.

If desired, in case of diamonds, it can be verified that the segmentation of the light performance parameters is correlated with the 4Cs segmentation. To this end, for each diamond in the statistically relevant sample, in addition to its selected parameter, whose values are obtained in step IA, its 4Cs are recorded: its carat size, its clarity grading, its color and its cut grade and the segmentations are compared. An example of such verification is as follows:
comparing 2 segments of the parameters' values, for which there is an expectation that the parameters' values for one segment will be higher than the other; for example, the expectation is that for high clarity diamonds (IF to VVS), with high color (D to F) and for high cut grade (Excellent), the values of the parameters should be statistically higher than diamonds with low clarity (I) low color (M and above) and low cut grade (Poor); or for example diamonds with the same color and clarity segments but differ by cut grade, the expectation that the value of parameters of the better cut grade will be statistically higher than these of worst cut grade.
if the statistics is according to the expectation/intentions, then the validity of the values of the respective parameters is established.

It is clear to a skilled person that many other strategies of verification, with different criteria as to what is to be expected/intended, are feasible; in this respect, the above example is by no means to be seen as limiting or exclusive.

In step III in FIG. 2, the unique ranges of values of the selected parameters are associated with the sub-grades from the sub-grades scale of each of the parameters. In the present example, the sub-grades of all the parameters form one single sub-grade scale, i.e. all the parameters are divided to have the same quantity of sub-grades.

The sub-grades can have specific descriptive names. In particular, the sub-grades can be named to support their use in the trade, the idea being of going from higher value to lower value.

One example of a quantity of sub-grades can be five with their names—Ultimate, Very High, High, Standard and Low, as illustrated in FIG. 3.

It should be clear to a skilled person that any reasonable quantity that is more than two can be assigned, depending on the goal of the grading scale, and that any other set of names or descriptors will do.

Each parameter is divided to the sub-grades based on setting borderlines so that all values which are below a higher borderline and above a lower borderline have the same sub-grade. The number of borderlines is equal to the number of sub-grades minus one.

In the example of FIG. 3, all values that are lower than borderline 1 and higher than borderline 2 belong to sub-grade 2.

The association of the unique ranges of values of the selected parameters with sub-grades should be based on a required statistics distribution of each sub-grade determined for each parameter. For example, it can be decided that the size of the top sub-grade (Ultimate) is set to 15%, the second sub-grade to 20%, the third sub-grade to 30%, the fourth sub-grade to 20%, and the lower sub-grade to 15%.

The statistics is also validated for typical segments of sub-grades of each parameter. For example, for the high quality segment, the distribution should be for the top sub-grade 30% and for the lowest sub-grade 5%, and for the low quality segment the distribution for the top sub-grade 10% and the lowest sub-grade should be 30%.

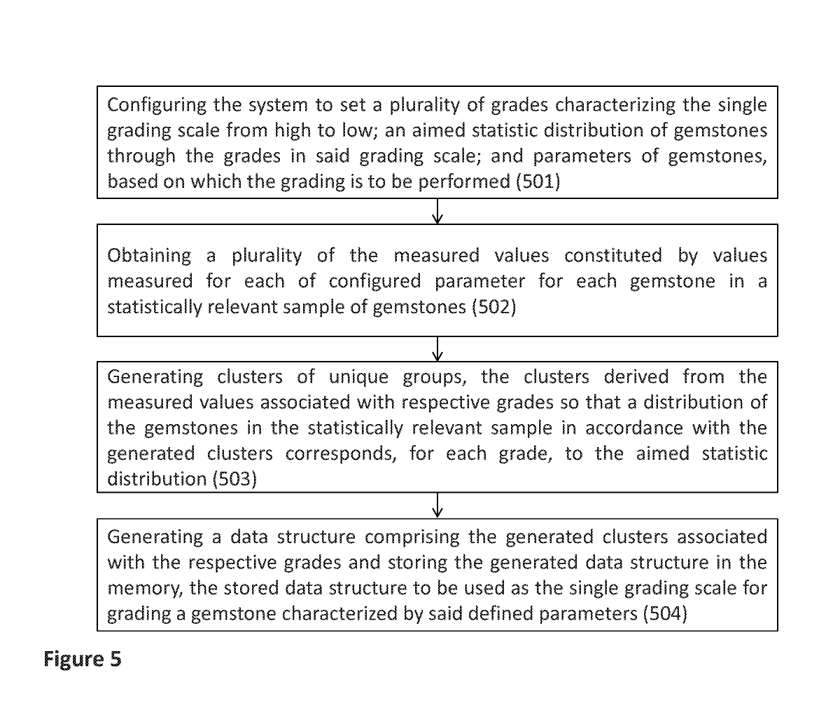

At this point, each gemstone in the database has for each of the parameters a sub-grade, and is thus characterized by a combination of four sub-grades (one—for each of the four parameters), as illustrated in FIG. 4, where examples of six gemstones are presented.

Using the above names of the sub-grades, the gemstone represented by third line in FIG. 4, has the following sub-grades for the four selected parameters:
Brilliance Ultimate
Fire Very High
Sparkle Ultimate
Symmetry Standard

Table 1 below presents one example of a list of unique groups of sub-grades and illustrates one possible manner of their weighting and rating. Table 2 below illustrates one example of clustering the unique groups rated in the Table 1 into final grades.

TABLE 15

| 5 | 4 | 3 | 2 | 1 | |
|---|---|---|---|---|---|
| Sub- | Sub- | Sub- | Sub- | Sub- | Factors |
| grade 1 | grade 2 | grade 3 | grade 4 | grade 5 | Rate |
| 4 | 0 | 0 | 0 | 0 | 20 |
| 3 | 1 | 0 | 0 | 0 | 19 |
| 3 | 0 | 1 | 0 | 0 | 18 |
| 3 | 0 | 0 | 1 | 0 | 17 |
| 3 | 0 | 0 | 0 | 1 | 16 |
| 2 | 2 | 0 | 0 | 0 | 18 |
| 2 | 1 | 1 | 0 | 0 | 17 |
| 2 | 1 | 0 | 1 | 0 | 16 |
| 2 | 1 | 0 | 0 | 1 | 15 |
| 1 | 3 | 0 | 0 | 0 | 17 |
| 2 | 0 | 2 | 0 | 0 | 16 |
| 2 | 0 | 1 | 1 | 0 | 15 |
| 2 | 0 | 1 | 0 | 1 | 14 |
| 1 | 2 | 1 | 0 | 0 | 16 |
| 2 | 0 | 0 | 2 | 0 | 14 |
| 2 | 0 | 0 | 1 | 1 | 13 |
| 1 | 2 | 0 | 1 | 0 | 15 |
| 2 | 0 | 0 | 0 | 2 | 12 |
| 1 | 2 | 0 | 0 | 1 | 14 |
| 0 | 4 | 0 | 0 | 0 | 16 |
| 1 | 1 | 2 | 0 | 0 | 15 |
| 1 | 1 | 1 | 1 | 0 | 14 |
| 1 | 1 | 1 | 0 | 1 | 13 |
| 0 | 3 | 1 | 0 | 0 | 15 |
| 1 | 0 | 3 | 0 | 0 | 14 |
| 1 | 1 | 0 | 2 | 0 | 13 |
| 1 | 1 | 0 | 1 | 1 | 12 |
| 0 | 3 | 0 | 1 | 0 | 14 |
| 1 | 0 | 2 | 1 | 0 | 13 |
| 1 | 1 | 0 | 0 | 2 | 11 |
| 0 | 3 | 0 | 0 | 1 | 13 |
| 1 | 0 | 2 | 0 | 1 | 12 |
| 0 | 2 | 2 | 0 | 0 | 14 |
| 1 | 0 | 1 | 2 | 0 | 12 |
| 1 | 0 | 1 | 1 | 1 | 11 |
| 0 | 2 | 1 | 1 | 0 | 13 |
| 1 | 0 | 0 | 3 | 0 | 11 |
| 1 | 0 | 1 | 0 | 2 | 10 |
| 0 | 2 | 1 | 0 | 1 | 12 |
| 1 | 0 | 0 | 2 | 1 | 10 |
| 0 | 1 | 3 | 0 | 0 | 13 |
| 0 | 2 | 0 | 2 | 0 | 12 |
| 1 | 0 | 0 | 1 | 2 | 9 |
| 0 | 2 | 0 | 1 | 1 | 11 |
| 1 | 0 | 0 | 0 | 3 | 8 |
| 0 | 1 | 2 | 1 | 0 | 12 |
| 0 | 2 | 0 | 0 | 2 | 10 |
| 0 | 1 | 2 | 0 | 1 | 11 |
| 0 | 0 | 4 | 0 | 0 | 12 |
| 0 | 1 | 1 | 2 | 0 | 11 |
| 0 | 1 | 1 | 1 | 1 | 10 |
| 0 | 0 | 3 | 1 | 0 | 11 |
| 0 | 1 | 0 | 3 | 0 | 10 |
| 0 | 1 | 1 | 0 | 2 | 9 |
| 0 | 0 | 3 | 0 | 1 | 10 |
| 0 | 1 | 0 | 2 | 1 | 9 |
| 0 | 0 | 2 | 2 | 0 | 10 |
| 0 | 1 | 0 | 1 | 2 | 8 |
| 0 | 0 | 2 | 1 | 1 | 9 |
| 0 | 1 | 0 | 0 | 3 | 7 |
| 0 | 0 | 1 | 3 | 0 | 9 |
| 0 | 0 | 2 | 0 | 2 | 8 |
| 0 | 0 | 1 | 2 | 1 | 8 |
| 0 | 0 | 0 | 4 | 0 | 8 |
| 0 | 0 | 1 | 1 | 2 | 7 |
| 0 | 0 | 0 | 3 | 1 | 7 |
| 0 | 0 | 1 | 0 | 3 | 6 |
| 0 | 0 | 0 | 2 | 2 | 6 |
| 0 | 0 | 0 | 1 | 3 | 5 |
| 0 | 0 | 0 | 0 | 4 | 4 |

TABLE 2

| Unique | | | | | | | |
|---|---|---|---|---|---|---|---|
| Group N | Sub-grade 1 | Sub-grade 2 | Sub-grade 3 | Sub-grade 4 | Sub-grade 5 | Rate | Final Grades |
| 1 | 4 | 0 | 0 | 0 | 0 | 20 | Final Grade 1 |
| 2 | 3 | 1 | 0 | 0 | 0 | 19 | Final Grade 2 |
| 3 | 3 | 0 | 1 | 0 | 0 | 18 | Final Grade 2 |
| 4 | 2 | 2 | 0 | 0 | 0 | 18 | Final Grade 2 |
| 5 | 3 | 0 | 0 | 1 | 0 | 17 | Final Grade 3 |
| 6 | 2 | 1 | 1 | 0 | 0 | 17 | Final Grade 3 |
| 7 | 1 | 3 | 0 | 0 | 0 | 17 | Final Grade 3 |
| 8 | 3 | 0 | 0 | 0 | 1 | 16 | Final Grade 3 |
| 9 | 2 | 1 | 0 | 1 | 0 | 16 | Final Grade 3 |
| 10 | 2 | 0 | 2 | 0 | 0 | 16 | Final Grade 3 |
| 11 | 1 | 2 | 1 | 0 | 0 | 16 | Final Grade 3 |
| 12 | 0 | 4 | 0 | 0 | 0 | 16 | Final Grade 3 |
| 13 | 2 | 1 | 0 | 0 | 1 | 15 | Final Grade 3 |
| 14 | 2 | 0 | 1 | 1 | 0 | 15 | Final Grade 3 |
| 15 | 1 | 2 | 0 | 1 | 0 | 15 | Final Grade 3 |
| 16 | 1 | 1 | 2 | 0 | 0 | 15 | Final Grade 3 |
| 17 | 0 | 3 | 1 | 0 | 0 | 15 | Final Grade 3 |
| 18 | 2 | 0 | 1 | 0 | 1 | 14 | Final Grade 4 |
| 19 | 2 | 0 | 0 | 2 | 0 | 14 | Final Grade 4 |
| 20 | 1 | 2 | 0 | 0 | 1 | 14 | Final Grade 4 |
| 21 | 1 | 1 | 1 | 1 | 0 | 14 | Final Grade 4 |
| 22 | 1 | 0 | 3 | 0 | 0 | 14 | Final Grade 4 |
| 23 | 0 | 3 | 0 | 1 | 0 | 14 | Final Grade 4 |
| 24 | 0 | 2 | 2 | 0 | 0 | 14 | Final Grade 4 |
| 25 | 2 | 0 | 0 | 1 | 1 | 13 | Final Grade 4 |
| 26 | 1 | 1 | 1 | 0 | 1 | 13 | Final Grade 4 |
| 27 | 1 | 1 | 0 | 2 | 0 | 13 | Final Grade 4 |
| 28 | 1 | 0 | 2 | 1 | 0 | 13 | Final Grade 4 |
| 29 | 0 | 3 | 0 | 0 | 1 | 13 | Final Grade 4 |
| 30 | 0 | 2 | 1 | 1 | 0 | 13 | Final Grade 4 |
| 31 | 0 | 1 | 3 | 0 | 0 | 13 | Final Grade 4 |
| 32 | 2 | 0 | 0 | 0 | 2 | 12 | Final Grade 4 |
| 33 | 1 | 1 | 0 | 1 | 1 | 12 | Final Grade 4 |
| 34 | 1 | 0 | 2 | 0 | 1 | 12 | Final Grade 4 |
| 35 | 1 | 0 | 1 | 2 | 0 | 12 | Final Grade 4 |
| 36 | 0 | 2 | 1 | 0 | 1 | 12 | Final Grade 4 |
| 37 | 0 | 2 | 0 | 2 | 0 | 12 | Final Grade 4 |
| 38 | 0 | 1 | 2 | 1 | 0 | 12 | Final Grade 4 |
| 39 | 0 | 0 | 4 | 0 | 0 | 12 | Final Grade 4 |
| 40 | 1 | 1 | 0 | 0 | 2 | 11 | Final Grade 4 |
| 41 | 1 | 0 | 1 | 1 | 1 | 11 | Final Grade 4 |
| 42 | 1 | 0 | 0 | 3 | 0 | 11 | Final Grade 4 |
| 43 | 0 | 2 | 0 | 1 | 1 | 11 | Final Grade 4 |
| 44 | 0 | 1 | 2 | 0 | 1 | 11 | Final Grade 4 |
| 45 | 0 | 1 | 1 | 2 | 0 | 11 | Final Grade 4 |
| 46 | 0 | 0 | 3 | 1 | 0 | 11 | Final Grade 4 |
| 47 | 1 | 0 | 1 | 0 | 2 | 10 | Final Grade 5 |
| 48 | 1 | 0 | 0 | 2 | 1 | 10 | Final Grade 5 |
| 49 | 0 | 2 | 0 | 0 | 2 | 10 | Final Grade 5 |
| 50 | 0 | 1 | 1 | 1 | 1 | 10 | Final Grade 5 |
| 51 | 0 | 1 | 0 | 3 | 0 | 10 | Final Grade 5 |
| 52 | 0 | 0 | 3 | 0 | 1 | 10 | Final Grade 5 |
| 53 | 0 | 0 | 2 | 2 | 0 | 10 | Final Grade 5 |
| 54 | 1 | 0 | 0 | 1 | 2 | 9 | Final Grade 5 |
| 55 | 0 | 1 | 1 | 0 | 2 | 9 | Final Grade 5 |
| 56 | 0 | 1 | 0 | 2 | 1 | 9 | Final Grade 5 |
| 57 | 0 | 0 | 2 | 1 | 1 | 9 | Final Grade 5 |
| 58 | 0 | 0 | 1 | 3 | 0 | 9 | Final Grade 5 |
| 59 | 1 | 0 | 0 | 0 | 3 | 8 | Final Grade 6 |
| 60 | 0 | 1 | 0 | 1 | 2 | 8 | Final Grade 6 |
| 61 | 0 | 0 | 2 | 0 | 2 | 8 | Final Grade 6 |
| 62 | 0 | 0 | 1 | 2 | 1 | 8 | Final Grade 6 |
| 63 | 0 | 0 | 0 | 4 | 0 | 8 | Final Grade 6 |
| 64 | 0 | 1 | 0 | 0 | 3 | 7 | Final Grade 7 |
| 65 | 0 | 0 | 1 | 1 | 2 | 7 | Final Grade 7 |
| 66 | 0 | 0 | 0 | 3 | 1 | 7 | Final Grade 7 |
| 67 | 0 | 0 | 1 | 0 | 3 | 6 | Final Grade 7 |
| 68 | 0 | 0 | 0 | 2 | 2 | 6 | Final Grade 7 |
| 69 | 0 | 0 | 0 | 1 | 3 | 5 | Final Grade 8 |
| 70 | 0 | 0 | 0 | 0 | 4 | 4 | Final Grade 9 |

The gemstone represented by third line in FIG. 4, as having in total the following sub-grades: 2 Ultimate, 1 Very High and 1 Standard, can be found in the eighth line in Table 1.

In another example, the gemstone represented by line 5 in FIG. 4, has the following sub-grades for the four selected parameters:
Brilliance Ultimate
Fire Very High
Sparkle Ultimate
Symmetry Ultimate

This gemstone has in total the following sub-grades: 3 Ultimate and 1 Very High, and it can be found in the second line in Table 1.

Still another gemstone may have 4 Ultimate and so on.

Since in FIG. 4 each of the 4 parameters has 5 sub-grades, there are in Table 1 altogether 70 possible combinations or unique groups of the total sub-grade numbers, which gemstones can have. If there were three parameters and five sub-grades, then there would be 35 unique groups.

Reverting to FIG. 2, in step IV, each unique group is rated from high to low. The highest rate is assigned for the unique group with all the parameters scoring the top sub-grade and the lowest rate is assigned for the unique group with all parameters scoring the lowest sub-grade.

One method of assigning rates can be setting a weighting factor to each sub-grade and examining the total score. For example, in the rating illustrated in Table 1, a weighting factor of 1 is given to the lowest sub-grade, and then for the next level a weighting factor of 2 (1; 2; 3; 4; 5 etc.) is given, the total rate being the multiplication of the weighting factor by the quantity of score in each sub-grade.

More particularly, with the 4 parameters and 5 sub-grades, the weighting factor of 5 is assigned to Ultimate sub-grades, the weighting factor of 4 is assigned to Very High sub-grades, the weighting factor of 3 is assigned to the High sub-grades, the weighting factor of 2 is assigned to the Standard sub-grades and the weighting factor of 1 is assigned to the Low sub-grades. In this case, gemstones with 4 parameters having the top sub-grades (4 Ultimate—as in the first line of the table in Table 1), will have the rate calculated by the multiplication of 5 by 4, which is 20. Where out of four parameters, there are 2 top sub-grades (Ultimate), 1 third sub-grade (High) and 1 the lowest sub-grade (Low), the rate will be 5×2+3×1+1×1=14 (as in the thirteen's line of the Table 1).

To facilitate further steps, in Table 1 the unique groups have been sorted in a sequence from the highest to the lowest rate.

To rate all the unique groups other methods can be used.

In step V illustrated in FIG. 2, all the unique groups are clustered into the final grades set in step 0B above.

The clustering is performed by assigning the same final-grade to unique groups with similar rates, with the result that sequential ranges of one or more rates will be assigned to one grade. At the end of the process of assigning unique groups to final-grades, every unique group is assigned to one final-grade in the single grading scale. This allows the rates to show a distribution across the grades, when there are more rates than grades.

In particular, with reference to Table 2, the 70 unique groups are clustered into 9 final-grades (see the rightmost column), by assigning to each one of the 9 final-grades, such a number of unique groups as to meet the aimed statistical distribution as discussed hereinabove.

Another method of clustering is looking for unique groups with equivalent and then similar performance One example of equivalence is as follows: a unique group with 2 top sub-grades (Ultimate) and 2 lowest sub-grades (Low) is equivalent to a unique group, where one of the two high sub-grades is downgraded (Ultimate to Very High) and one of the two low sub-grades is upgraded (Low to Standard), resulting in the unique group with 1 top sub-grade (Ultimate), 1 second sub-grade (Very High), 1 forth sub-grade (Standard) and 1 lowest sub-grade (Low). One example of similar performance is as follows: a unique group with 3 top sub-grades (Ultimate) and 1 forth sub-grade (Standard) is similar, but superior, to a unique group with 3 top sub-grades (Ultimate) and 1 lowest sub-grade (Low).

The above methods can be combined in any desired combination.

In step VI illustrated in FIG. 2, the obtained distribution of the final-grades in the database is compared to the aimed statistical distribution as set before.

If the actual distribution doesn't meet the required distribution, then, in accordance with the above described methods, at least one of the following actions is performed:
at least one unique group from one final-grade is re-assigned to a neighboring final-grade; this is done by choosing from the unique groups in the specific final-grade
   at least one unique group with the highest rate in that grade and upgrading this unique group to the neighboring higher final-grade; and/or
   at least one unique group with the lowest rate in the grade and downgrading it to neighboring lower final-grade;
during this process, groups that have equivalent performance are moved all at once, and only groups that are not similar to one another are allowed to move separately;
re-defining unique ranges by shifting at least one borderline between at least two unique ranges.

The process is performed until the actual distribution of final-grades is very close (within 0.5%) to the aimed statistical distribution of the database, and each one of the unique groups is assigned to a final-grade in the single grading scale.

With reference to Table 2, the final single grading scale is presented (rightmost column) in association with unique groups of the corresponding sub-grades, obtained as a result of steps V and VI, in which care has been taken that the top final-grade should have, for example, 8% of the gemstones from the statistically relevant sample, the next grade should have 10% and so on.

To summarize the above, the following information defines the grading scale produced as described above:
The definitions of the parameters (in the specific example illustrated in the drawings—4 parameters);
The quantity of sub-grades of the parameters (in the above specific example—5 sub-grades);
The borderlines that dissect the values of each parameter to sub-grades (in the specific example—4 borderlines to generate the 5 sub-grades);
The unique groups of parameters and sub-grades based on counting the same sub-grades (in the above specific example—70);
The quantity of final-grades of the single grading scale (in the above specific example—9);
Assignment of each unique group to one final-grade.

The scale defined by the above information is thus recorded on a non-transitory computer-readable medium, e.g. computer memory, which further includes instructions on its use for grading gemstones.

The quantity of final-grades in the above specific example is 9, but there can be any other appropriate quantity. In the above example, the final-grades do not have any specific names and are just numbered, but they can have descriptive names that will support their use in the trade. One example of such names for 9 final-grades is the following (from high to low): ULTIMATE***, ULTIMATE**, ULTIMATE*, PREMIUM**, PREMIUM*, CLASSIC**, CLASSIC*, LOW**, LOW*.

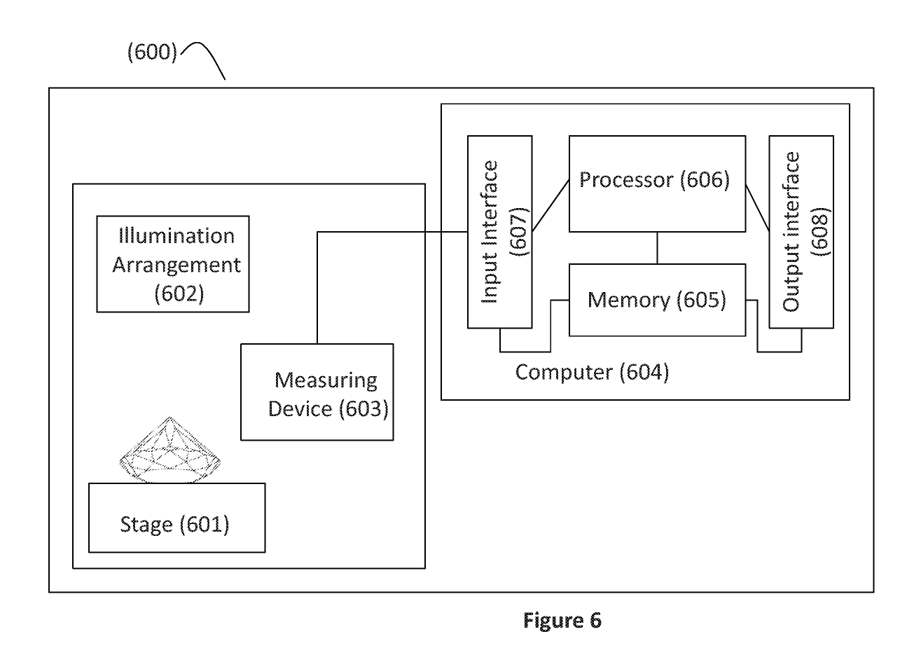

Referring to FIG. 5, there is presented a generalized flow-chart of operating the system 100 when producing a single grading scale for gemstones in general, and particularly the single grading scale described above.

The method of operating the system 100, when producing a single grading scale, comprises, in accordance with the description above and FIGS. 2-4, configuring (501) the system to set at least:
a plurality of grades characterizing the single grading scale from high to low;
an aimed statistic distribution of gemstones through the grades in said grading scale; and
parameters of gemstones, such as e.g. light performance parameters, based on which the grading is to be performed.

Data for configuring can be provided by a user (e.g. via the second input interface 103 configured as a graphical user interface). Optionally, at least part of the configuration data can be received from external sources responsive to instructions provided by the user and/or the processor 104. The configuration data can be stored in the memory 101.

The method further comprises obtaining (502) in the memory 101 (e.g. via the first input interface 102) values of each of the parameters for each gemstone in the statistically relevant sample of gemstones, thus giving rise to a plurality of the values for each parameter out of the set parameters. The statistically relevant sample of gemstones can be obtained as described above with reference to FIGS. 2-4. The plurality of values can be received from one or more suitable databases or derived from data existing in the one or more databases in accordance with instructions provided by a user and/or the processor 104. Optionally, the obtaining can include measuring at least a part of the values responsive to instructions provided by the processor 104 or deriving the values from measured data (such data can be derived e.g. from images taken under lighting conditions suitable for revealing each parameter being evaluated).

The processor 104 (e.g. the clustering module 105) processes the obtained plurality of values in accordance with the configuration data and generates (503) clusters of unique groups. The clusters are associated with the respective grades and are generated so that a distribution of the gemstones in the statistically relevant sample in accordance with the generated clusters corresponds, for each grade, to the aimed statistic distribution.

The processor (e.g. the single grading scale generation module 106) generates (504) a data structure comprising the generated clusters associated with the respective grades and stores the generated data structure in the memory, the stored data structure to be used as the single grading scale for grading gemstones based on their defined parameters.

The processor can further set for each of the parameters a scale of sub-grades from high to low and assign to each such sub-grade of each defined parameter one unique value range. Generating the clusters can thus include the operation of generating unique groups of the unique value ranges, each unique group constituted by one unique range for each of the defined parameter. Further, the processor can assign for each unique group of the unique ranges a respective rate and cluster the unique groups in accordance with the assigned rates.

The unique groups of the unique ranges can be generated in accordance with an aimed statistic distribution of gemstones through the sub-grades in the single scale of sub-grades for each of the defined parameters.

The processor can also generate a single scale of sub-grades for all the defined parameters using a scale of sub-grades which can be set for each of the defined parameters.

The processor can generate the clusters by including the operation of comparing the distribution of the gemstones in the statistically relevant sample in accordance with the generated clusters with the aimed statistic distribution, and if the aimed distribution is not reached, by further including the operation of performing at least one of the following steps in order to bring the former distribution into conformity with the latter distribution: re-defining unique ranges or re-clustering unique groups for at least two grades.

The processor can further perform the step of re-clustering unique groups by re-assigning to a new final-grade at least one unique group previously assigned to a previous final-grade, said new and said previous final-grades being neighboring final-grades.

Referring to FIG. 6, there is illustrated a system 600 capable of grading a gemstone using the single grading scale generated as detailed above. The system comprises:
a stage 601 for mounting a gemstone G thereon;
an illumination arrangement 602 configured to generate different light environments to facilitate the conditions needed for the measuring of the parameters; this entails generating lighting conditions suitable for revealing each specific parameter being measured;
a measuring device 603 configured to receive the light return from the gemstone; a computer 604 operatively connected to the measuring device 603 and configured to receive therefrom the measured signal.

The computer 604 comprises a memory 605 operatively coupled to a processor 606. The memory 605 is implemented on a non-transitory media and stores data necessary for grading. Such data can include the single grading scale; an algorithm to be used by the processor to determine values of each parameter from the measured signals; borderlines for each parameter to determine by the processor the sub-grade of each parameter; and the rules of assignment by the processor of each unique group of sub-grades to a final grade in the single grading scale, etc. Optionally, during the grading process, at least part of these data can be received in real time from one or more external sources via an input interface 607. Alternatively or additionally, at least part of these data can be accommodated in the memory 605 before the grading process.

The computer further comprises an output interface 608 (e.g. a communication port) configured to communicating the results such as, for example a report on the measured gemstone. The report can, for example, presents the sub-grade for each parameter and the final grade in the single grading scale, established according to the method described hereinabove.

In case of a diamond, the report can further include the 4Cs of the diamond, a QR code to access the report in the Internet, images of the diamond as being taken during the process of measuring the parameters.

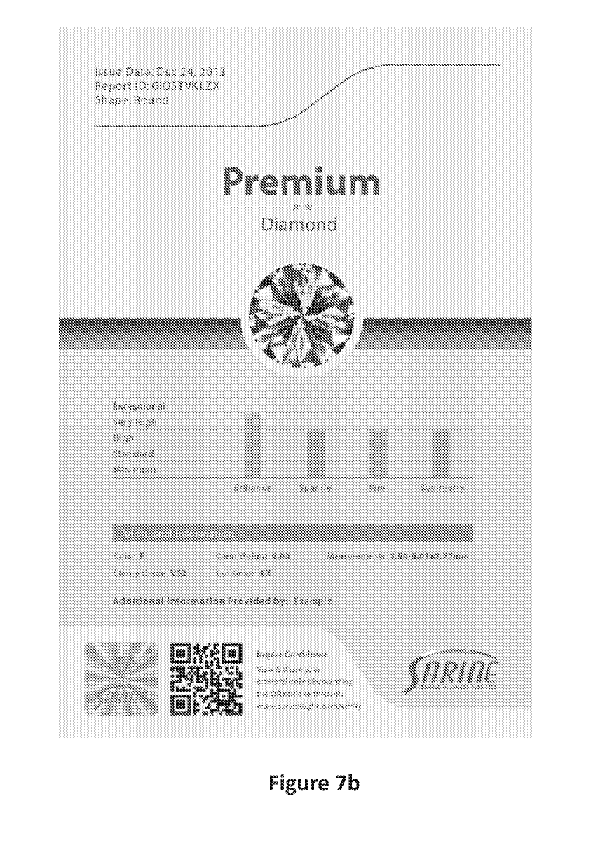

Non-limiting examples of possible reports are presented in FIGS. 7A and 7B.

In the report presented in FIG. 7A, the above names of the sub-grades are used (Ultimate, Very High, High, Standard and Low) and in the report presented in FIG. 7B some of the sub-grades are name differently (Exceptional instead of Ultimate and Minimal instead of Low). The name of the final grade in the report of FIG. 7A is ‘Ultimate***’ and that of FIG. 7B is ‘Premium**’.

Optionally, the system 600 can comprise the system 100 or can be operatively connected to the system 100 to receive therefrom data usable for the grading process.

The computer 604 can be integrated with a conventional system, which can measure light performance parameters of gemstones This can, for example, be the system sold under the trade name Sarine Light™ or the system known under the trade name ISEE2™ or the systems described in U.S. Pat. No. 6,786,733 and U.S. Pat. No. 8,116,552 B2, each incorporated herein by reference. These systems have components of the kind described above and can be operated to derive light performance parameters of a gemstone from its images obtained by an electronic imaging system under different lighting conditions. In particular, the illumination arrangement of the system can be configured for illuminating the gemstone with spatially varied light pattern, and the measuring device can be in the form of a camera that captures electronic images of the gemstone and outputs them as the measured signals, which are processed by the processor to determine the values of the light performance parameters. In the described example, these parameters are Brilliance, Scintillation or Sparkle, Fire and Light Symmetry, and their values can be determined from the measured signals in the manner as described and claimed in the above patents and their families. Still more particularly, the algorithm used by the processor for determining values of each light performance parameter of the gemstone from the measured signals can comprise instructions to select a first image portion from a first electronic image of the gemstone which was captured under a first lighting condition, the first image portion comprising one or more pixels corresponding to a region of the gemstone; to select a second image portion from a second electronic image of the gemstone which was captured under a second lighting condition, the second image portion comprising one or more pixels corresponding to the same region of the gemstone as the first image portion; and to compare the first image portion with the second image portion. Still more particularly, the comparison can be performed of the intensity of light at the first image portion with the intensity of light at the second image portion, and/or of color components of the first image portion with color components of the second image portion.

Note that the currently disclosed subject matter is not bound by the system described with reference to FIG. 6. Equivalent and/or modified functionality can be consolidated or divided in another manner and can be implemented in any appropriate combination of software, firmware and hardware, (e.g. in a suitably programmed computer). Furthermore, instead of measuring the light performance parameters of a gemstone, they can be calculated based on the application of ray-tracing methods to a computer-generated 3D model of the external surface of the gemstone, which can optionally include computer generated models of internal inclusions in the gemstone. Non-limiting examples of systems and methods that can be used for producing such 3D models can be those in the following US patents:
U.S. Pat. No. 6,567,156, which discloses silhouettes-based 3D mapping of the external surface of a gemstone, which can be combined with structured light triangulation for imaging concavities thereon; and
U.S. Pat. No. 7,800,741, which discloses mapping inclusions inside a gemstone and incorporating them into a 3D model of the gemstone's external surface, which can be of the kind disclosed in U.S. Pat. No. 6,567,156.

Description of the systems and methods described in the above US patent are incorporated herein by reference.

Known systems using the above methods are, for example, systems produced by Sarine Technologies Ltd, Israel, under the trade names DiaMension™ and DiaVision™, and by Galatea Ltd., Israel, under the tradename Galaxy™.

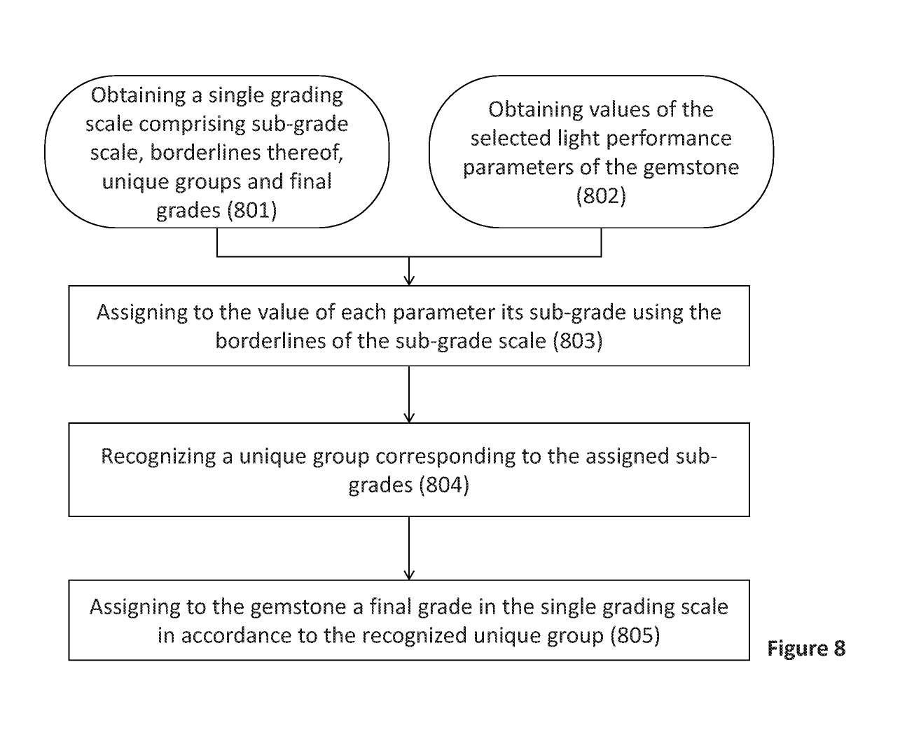

Referring to FIG. 8, there is illustrated a generalized flow chart of grading a diamond using the single grading scale as described above.

Upon obtaining (801) a single grading scale including a sub-grade scale and borderlines thereof for each parameter, unique groups of values of the parameters and final grades, and obtaining (802) values of the selected light performance parameters of the diamond to be graded, the computer 604 assigns (803) to the value of each parameter its sub-grade using the borderlines of the sub-grade scale. The computer further recognizes (804) a unique group corresponding to the assigned sub-grades and assigns (805) to the gemstone a final grade in the single grading scale in accordance with the recognized unique group.

For example, the values can be obtained by their measurement in the diamond; thus, for example, the diamond can have:
Brilliance 65
Fire 85
Sparkle 92
Symmetry 82

By way of non-limiting example, the computer can assign the borderlines of the sub-grade scale as follows:

| | Borderline 1 | Borderline 2 | Borderline 3 | Borderline 4 |
|---|---|---|---|---|
| Brilliance | 80 | 60 | 40 | 20 |
| Fire | 90 | 72 | 55 | 35 |
| Sparkle | 85 | 75 | 50 | 15 |
| Symmetry | 90 | 70 | 40 | 30 |

Thus, the sub-grades assigned to each of the parameters will be: Brilliance sub-grade—2 (65 is lower than borderline 1 and higher than borderline 2); Fire sub-grade—2; Sparkle sub-grade—1; Symmetry sub-grade—2;

With the above sub-grades constituting the following unique group of sub-grades: 1—of sub-grade 1 and 3—of sub-grade 2, the computer will then assign to this group a final grade in the single grading scale; using the Table 2, this diamond will then be assigned the final-grade of 3 (unique group No. 7).

In different embodiments of the currently presented subject matter the functional blocks and/or parts thereof may be placed in a single or in multiple geographical locations; operative connections between the blocks and/or within the blocks may be implemented directly (e.g. via a bus) or indirectly, including remote connection.

It is clear to the skilled person that the above description only serves as an exemplary case, without any limiting power to the described method, system and report to such example, and that the single grading scale and its sub-grade scale can be obtained in a large variety of ways without departing from the spirit of the above described process, system and report.

It will also be understood that the system according to the invention may be, at least partly, a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Those skilled in the art will readily appreciate that various modifications and changes can be applied to the embodiments of the invention as hereinbefore described without departing from its scope, defined in and by the appended claims.

1. A computerized method of grading a gemstone based on its light performance parameters, the method comprising:
upon obtaining in a memory of a computer a single grading scale including for each parameter a sub-grade scale, borderlines thereof, unique groups of values of the parameter and final grades corresponding to the unique groups; and upon obtaining values of the parameters of the gemstone to be graded, providing by a processor of the computer the following:
assigning to the obtained value of each parameter its sub-grade using the sub-grade scale and borderlines thereof specified in the single grading scale;
recognizing among the unique groups specified in the single grading scale a unique group corresponding to the assigned sub-grades; and
assigning to the gemstone, in accordance with the recognized unique group, a final grade in the single grading scale.

2. The method of claim 1, wherein the parameters comprise at least one of brilliance, fire, sparkle and light symmetry.

3. The method of claim 1 or 2, wherein distribution of the unique groups in the single grading scale corresponds to a distribution of gemstones in a statistically relevant sample of gemstones, optionally for diamonds, established based on the use of the 4Cs grading system.

4. The method of claim 1, 2 or 3, wherein the values of the parameters of the gemstone are obtained by deriving thereof from image data obtained by electronic imaging of the gemstone.

5. A system capable of grading a gemstone based on its light performance parameters, the system comprising:
a memory configured to store a single grading scale including for each parameter a sub-grade scale, borderlines thereof, unique groups of values of the parameter and final grades corresponding to the unique groups, and to obtain for at least temporal storage values of the parameters of the gemstone to be graded; and
a processor operatively connected to the memory and configured to:
assign to the obtained value of each parameter its sub-grade using the sub-grade scale and borderlines thereof specified in the single grading scale;
recognize among the unique groups specified in the single grading scale a unique group corresponding to the assigned sub-grades; and
assign to the gemstone, in accordance with the recognized unique group, a final grade in the single grading scale.

6. The system of claim 5, wherein the parameters comprise at least one of brilliance, fire, sparkle and light symmetry.

7. The system of claim 5 or 6, wherein distribution of the unique groups in the single grading scale corresponds to a distribution of gemstones in a statistically relevant sample.

8. The system of claim 5, 6 or 7, further comprising a stage for mounting a gemstone thereon; an illumination arrangement configured to generate different light environments, electronic imaging device for obtaining electronic images of the gemstone under said different light environments and producing corresponding measured signals; and a computer operatively connected to the electronic imaging device and configured to receive therefrom the measured signals and derive from said signals values of said parameters.

9. The system of claim 8, wherein said processor constitutes said computer.

10. A non-transitory computer readable storage medium comprising computer readable program code embodied therein for operating a system capable of grading a gemstone, the computer readable program code causing the system:
upon obtaining in a memory of a computer a single grading scale including for each parameter a sub-grade scale, borderlines thereof, unique groups of values of the parameter and final grades corresponding to the unique groups, and upon obtaining values of the parameters of the gemstone to be graded, to assign to the obtained value of each parameter its sub-grade using the sub-grade scale and borderlines thereof specified in the single grading scale;
to recognize among the unique groups specified in the single grading scale a unique group corresponding to the assigned sub-grades; and
to assign to the gemstone, in accordance with the recognized unique group, a final grade in the single grading scale.

11-28. (canceled)

29. A gemstone grading report recorded on a computer memory, and comprising indication of a grade for the gemstone in a single grading based on pre-defined parameters thereof, wherein each single grade in said scale is associated with a unique group of rates; each rate corresponding to one unique combination of value ranges of all the parameters in gemstones from a statistically relevant sample of gemstones, each value range corresponding to a sub-grade in a single sub-grade scale for all the parameters; the unique combination of value ranges being based on an aimed statistic distribution of gemstones through the grades in said grading scale.

30. The gemstone grading report of claim 29, further comprising a sub-grade for each parameter in said single sub-grade scale.

31. The gemstone grading report of claim 29 or 30, wherein said parameters comprise at least one of brilliance, fire, sparkle and light symmetry.

32. (canceled)
